(19) United States
(12) Patent Application Publication
(10) Pub. No.: US 2016/0131366 A1
(43) Pub. Date: May 12, 2016

(54) OVEN RANGE VENTILATOR WITH MICROWAVE COMPARTMENT

(71) Applicant: Foremost Groups, Inc., East Hanover, NJ (US)

(72) Inventors: Liang Chou Chen, Randolph, NJ (US); Michael Paitchell, Clifton, NJ (US)

(73) Assignee: Foremost Groups, Inc., East Hanover, NJ (US)

(21) Appl. No.: 14/932,536

(22) Filed: Nov. 4, 2015

Related U.S. Application Data
(60) Provisional application No. 62/077,571, filed on Nov. 10, 2014.

(51) Int. Cl. F24C 15/20; H05B 6/64; F24C 15/30

(52) U.S. Cl. CPC F24C 15/2042; F24C 15/2035; F24C 15/2064; F24C 15/2071; F24C 15/30; H05B 6/6408

(57) ABSTRACT

A ventilator hood assembly for mounting above a residential cooking range. The assembly includes a lower housing with a filter for capturing particulates entrapped in the air as it is drawn in from below the lower housing, and an upper section including a blower unit powered by a motor. The blower unit draws air in from the open bottom through the filter and expels air into an exhaust duct. An upper plenum is located below the blower unit and channels air into the blower unit. A microwave compartment is located above the lower housing and below the upper plenum. An intermediate conduit is located behind at least a back wall of the compartment and is connected to the lower housing and the upper plenum so as to provide a channel through which air from the cooktop can flow to the blower unit.

### RELATED APPLICATION

This application is related to and claims priority from U.S. Provisional Application 62/077,571, filed Nov. 10, 2014, which is incorporated herein by reference in its entirety.

### FIELD OF THE INVENTION

The present invention is directed to a ventilator for a range and, more particularly, to a ventilator with a duct configured to extend around a compartment for housing a microwave.

### BACKGROUND

Microwave units are now considered a mainstay in a kitchen in just about every home. There are various types of microwaves, including countertop units that sit on top of the kitchen counter, built-in drawer units that are mounted in drawer of a cabinet and open similar to a standard drawer, and over range units, which are mounted to the wall or under an existing cabinet that is above a range.

Most over the range units include an integral ventilator unit with a hood positioned below the microwave and which includes a small blower that drawings smoke and heat from underneath and channels it to vents on the front of the hood.

Due to the fact that the hood must have a small profile (height) so as not to position the microwave too high, the blower unit is generally very small.

Modern day cooking ranges have grown not only in size, but in the number of BTUs that they produce. Higher-end units approach the cooking capacity of industrial ranges. As such, these ranges generate substantial heat, which cannot be evacuated sufficiently with conventional blowers in over range microwave units.

As such, most high-end ranges have a high-flow blower units that require hoods with exhaust ducting out of the home. As such, conventional microwaves cannot be mounted over the range when such high-flow blowers and hoods are installed.

### SUMMARY OF THE INVENTION

A ventilator hood assembly for mounting to a wall above a residential cooking range. The assembly includes a lower housing with a filter for capturing particulates entrapped in the air as it is drawn in from below the lower housing, and an upper section including a blower unit powered by a motor. The blower unit draws air in from the open bottom through the filter and expels air into an exhaust duct. An upper plenum is located below the blower unit and channels air into the blower unit.

A microwave compartment is located above the lower housing and below the upper plenum. The compartment includes a base, a back wall, a top wall and two side walls.

An intermediate conduit is located behind at least the back wall of the microwave compartment and is connected to the lower housing and the upper plenum so as to provide a channel through which air and fumes from the cooktop can flow to the blower unit. The lower end of the conduit has an opening that connects to an opening in the lower housing above the filter. The upper end of the conduit has an opening that connects to an opening in the upper plenum below the blower.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

The above and other aspects, features, and advantages of the present invention may be more apparent from the following more particular description of embodiments thereof, presented in conjunction with the following drawings. In the drawings:

FIG. 1 is a general view of a ventilator hood according to the present invention installed over a cooking stove.

FIG. 2 is a perspective view of the hood ventilator of FIG. 1.

FIG. 3 is cross-sectional a side view of the hood ventilator of FIG. 1.

FIG. 4 is a cross-sectional front view of one embodiment of the hood ventilator of FIG. 1 with two separate plenums mounted into the wall.

FIG. 5 is a cross-sectional front view of the plenum arrangement of FIG. 4, taken along lines 5-5 in FIG. 4.

FIG. 6 is a cross-sectional front view of the plenum arrangement of FIG. 4, taken along lines 6-6 in FIG. 4.

### DESCRIPTION OF THE EMBODIMENTS

A better understanding of various features and advantages of the present methods and devices may be obtained by reference to the following detailed description of illustrative embodiments of the invention and accompanying drawings. Although these drawings depict embodiments of the contemplated methods and devices, they should not be construed as foreclosing alternative or equivalent embodiments apparent to those of ordinary skill in the subject art.

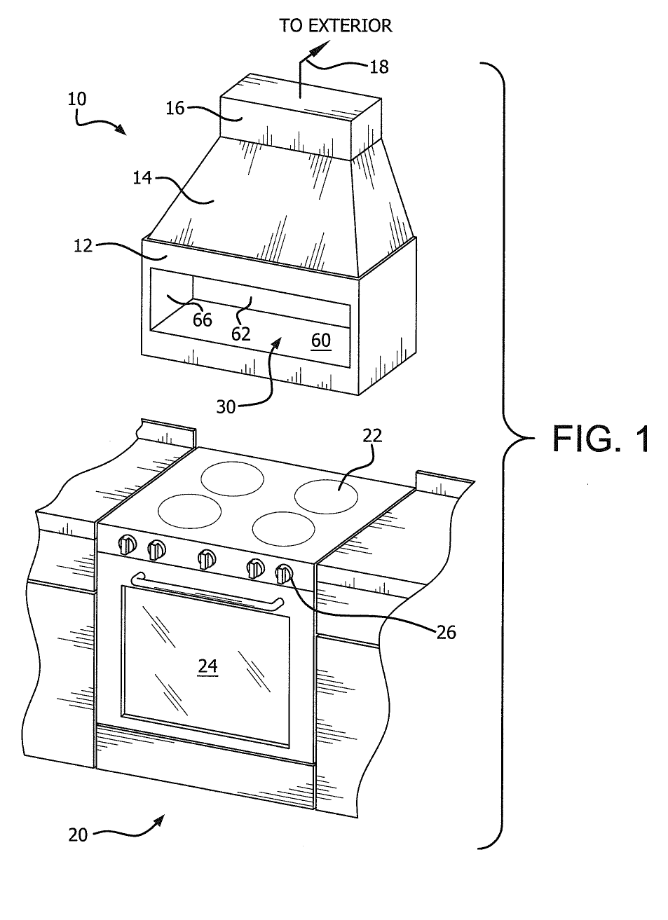

Referring to the drawings, and initially to FIG. 1, a ventilator hood indicated generally by the reference numeral 10 is shown mounted to a wall in a building. The ventilator hood 10 comprises a wide lower portion 12, a tapered middle portion 14, and a narrower top portion 16. The top portion 16 of the hood 10 is connected by external ducting 18 (not shown in detail) to the exterior of the building. The hood 10 may include an outer facade or housing made of wood, metal or other suitable material.

Below the hood 10, when mounted in a building structure, is generally a cooking stove or range indicated 20. The stove 20 may include one or more grates or hot plates 22, an oven 24, and appropriate controls 26.

In order to accommodate the use of a microwave, the lower portion 12 includes a microwave compartment 30 located above an open bottom 32 of the lower portion.

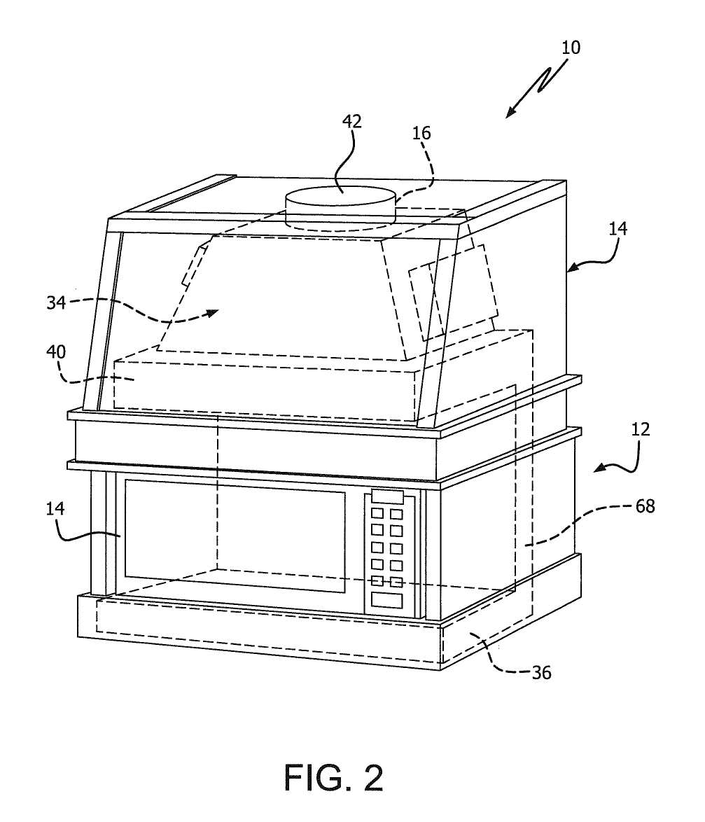

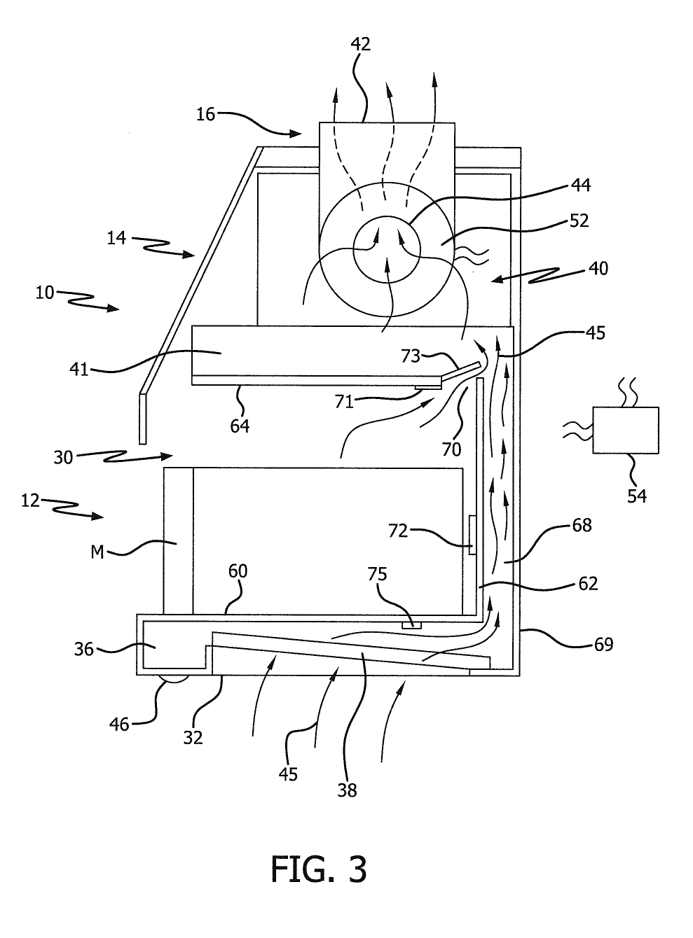

Referring to FIGS. 2 and 3, mounted within the hood 10 is a ventilator assembly 34. The ventilator assembly 34 has a lower housing 36 located within the lower portion 12 of the hood 10. The lower housing 36 includes a filter 38 for capturing particulates entrapped in the air as it is drawn in from below. The ventilator assembly 34 has an upper section 40, including a fan or blower unit 44 that, in operation, draws air in from the open bottom 32 through the filter 34 and expels air upwards through an outlet 42 that connects to the exhaust ducting 18, and an upper plenum 41 that channels the air into the blower unit 44.

The hood 10 can be made in various sizes, some of which are more or less standard. The external dimensions of the ventilator assembly 34 may be chosen to fit within the smallest hood size available. The ventilator assembly 34 may then be provided with additional or adjustable mounting brackets or other components to fit larger sizes of hood 10. For example, if the internal dimensions of the lower portion 12 of the hood 10 are larger than, and/or a different shape from, the external dimensions of the lower housing 36 of the ventilator assembly 34, suitable mounting plates may be provided to close off the space between the ventilator 34 and the hood 10. The lower housing 36 of the ventilator assembly 34 is preferably made of suitable material for accommodating the temperatures and conditions that are expected, such as stainless steel or aluminum which is strong, reasonably economical, and easy to keep clean.

On the underside of the ventilator assembly 34 there are lights 46 for illuminating the cooktop of the stove 20. The lower housing 36 of the ventilator assembly 34 also includes control knobs or switches (not shown) for controlling the fan 44 and the lights 46. Of course it should be readily understood that the control switches may be placed at any suitably accessible location, such as a front surface of the hood 10. The switches could be toggles, slides, or depression switches.

The fan 44 that draws air out through the ventilator assembly 34 is powered by a motor 52. The motor 52 speed is powered through a controller 54 from an electrical source, which may be the building wiring. The controller 54 can control the speed of the motor 52 in any appropriate manner depending on the type of motor 52 being used. Various types of electric motors and various ways of controlling the speed of an electric motor are well known. It is contemplated that the control system described in U.S. patent application Ser. No. 14/527,404, titled “Control System for Ventilator,” the disclosure of which is incorporated herein by reference in its entirety, could be used in the ventilator assembly 34.

As mentioned above, the hood 10 includes a microwave compartment 30 located above the open bottom 32 of the lower portion 12 of the hood. The compartment 30 preferably includes a base 60, a back wall 62, a top wall 64 and two side walls 66. The compartment 30 is preferably sized to accommodate a conventional microwave unit. The lower housing 36 of the ventilator assembly 34 is located below the base 60. The upper plenum 41 of the ventilator assembly 34 is preferably located above the top wall 64. In order to connect the lower housing 36 to the upper plenum 41 and, in particular, to the blower 44, for exhausting air and fumes 45 from the cooktop to the exhaust ducting 18, the ventilator assembly 34 includes an intermediate conduit 68 that connects the lower housing 36 to the bottom of the upper plenum 41. As shown in one embodiment in FIG. 3, the conduit 68 extends between the back wall 62 of the compartment 30 and a back wall 69 of the hood or the wall of the building. It is contemplated that there may be additional conduits (not shown) along the sides of compartment (between the side walls 66 and the sides of the hood.)

Since a microwave M mounted in the compartment may also require some degree of exhausting or venting, a vent 70 may be formed in the back wall 62 or in the top wall 64 (as shown) for permitting air communication into the conduit 68 or upper plenum 41. A flapper valve 73 may be included to control the opening of the vent 70. A temperature sensor 71 could be included to sense the temperature of the compartment 30. If the sensor 71 detects heat emanating from the microwave or in the compartment that is above a predetermined temperature, a signal could be sent to the controller 54 to turn the exhaust fan on low. The airflow would pull open the flapper valve and, thereby, exhaust the heated air from the compartment 30. The vent 70 and flapper valve 73 are preferably sized so that only about 5%-10% of the entire air flow comes from the microwave compartment with the remainder being drawn up from the range.

It is also contemplated that in order to facilitate the supply of power to a microwave in the compartment an electrical outlet 72 may be formed on the back wall 62 or side walls 66 of the compartment. The wiring for the outlet could connect to same wiring that supplies power to the fan or could be separately wired to the building.

Unlike conventional microwave hoods which include fan mounted below the microwave and are limited to an exhaust speed of about 200 CFM, the present invention permits use of a commercial grade fan capable of exhausting 600 CFM or more of air.

If desired, one or more doors (not shown) can be added to the hood 10 to cover the compartment to hide the microwave. The doors can be configured to resemble the remainder of the hood, for example having an external wood appearance. There could be two doors that open to the sides. Alternatively, there could be a single door that swings upward or that slides upward, such as behind the sloping front of the tapered portion of the hood.

A temperature sensor 75 may be mounted at or near the open bottom 32 and is connected to the controller 54 for turning the fan on when a high temperature is sensed. If the fan is already on, the controller 54 could be programmed to turn the fan to a higher setting.

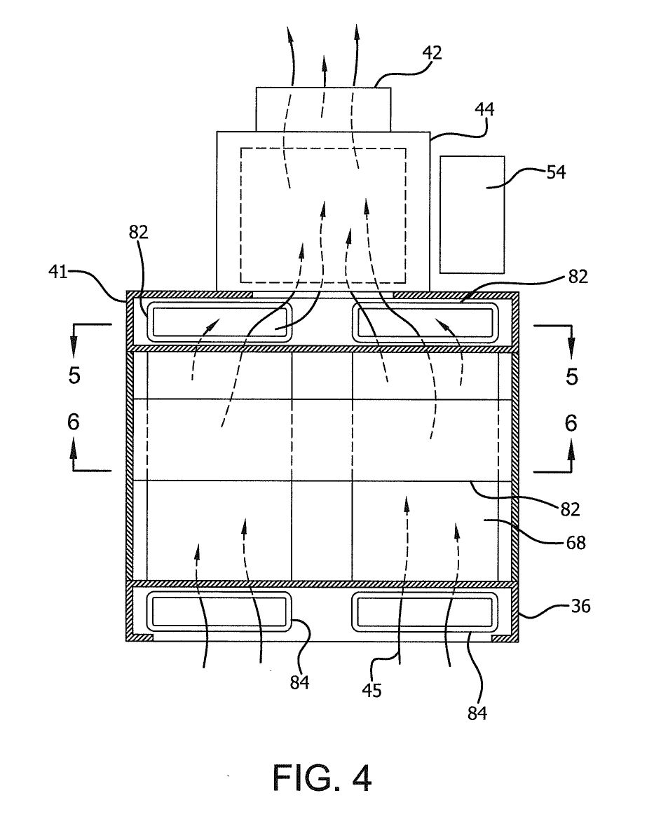

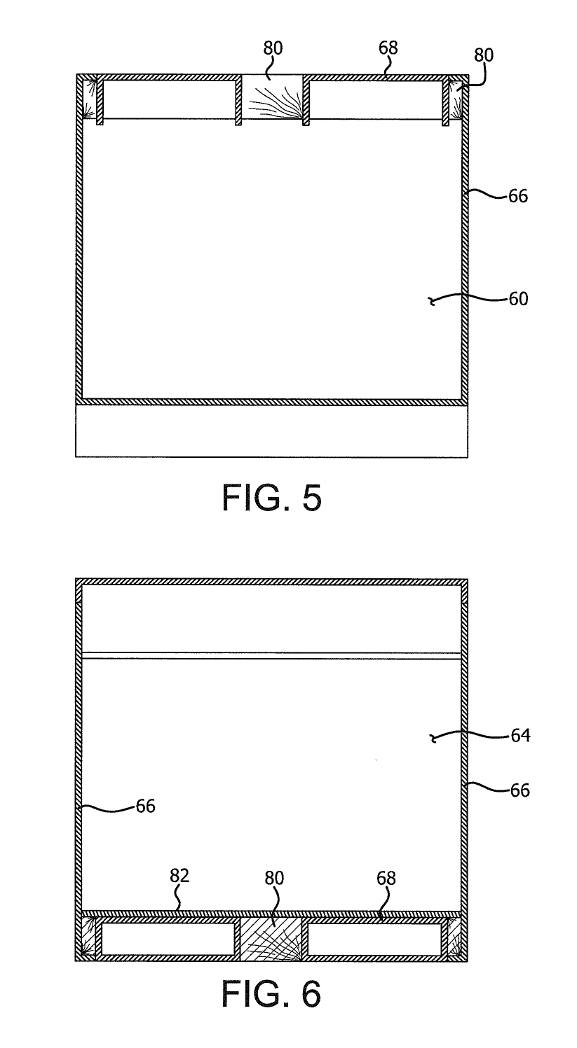

Referring now to FIGS. 4-6, an alternate embodiment of the ventilator assembly 34 is shown which mounts the intermediate conduits 68 at a spacing that corresponds to the spacing of the existing supports in the walls. More particularly, most residential buildings include vertical wood or metal supports (typically 2×4 inch wood beams) that are spaced, by local building code a maximum distance (typically either 12 inches or 16 inches). In this embodiment, the conduits 68 can be rectangular metal channels, such as made from aluminum. The upper and lower ends of the conduits 68 include curved elbow portions that connect with or extend into openings 82, 84 in the rear wall of the upper plenum 41 and lower housing 36, thereby providing a channel for the air to flow 45 from the filter to the blower 44.

The upper plenum 41 and lower housing 36 are attached to the wall as with the previous embodiment. The conduits 68 are preferably mounted to or positioned on the wall between where the wall supports or beams are located. For configurations where the microwave is not intended to sit on the base 60 but, instead, mount from its rear on a bracket attached to the wall, if there is no back wall 62 on the compartment, there will not be a surface for the bracket to attach to since the conduits will extend out from the wall. In this embodiment, in order to provide a mounting surface for the microwave, standoffs 80 are preferably mounted to the wall support beams on the sides of the conduits 68 between the upper plenum 41 and the lower housing 36. The standoffs 80 could be made from sheet metal or wood as shown, and would have a thickness at least the same as a depth of the conduits 68. Thus, a conventional microwave bracket 82 can be attached to the standoffs 80 for providing a mounting surface for a microwave inside the compartment.

In a further embodiment of the ventilator assembly 34, instead of the conduits 68 being mounted to the wall surface, the conduits 68 could, instead be mounted directly between the wall supports (inside the wall).

Although the present invention has been described as having a portion of the hood surrounding portions of the ventilator assembly, such external hood portions are not required.

1. A ventilator hood assembly for mounting to a wall above a residential cooking range, the assembly comprising:
a lower housing including a filter for capturing particulates entrapped in the air as it is drawn in from below the lower housing;
an upper section including a blower unit powered by a motor, the blower unit, in operation, configured to draw air in from the open bottom through the filter and expel air through an outlet into an exhaust duct, and an upper plenum that channels the air into the blower unit;
a controller for controlling speed of the motor;
a microwave compartment located above the lower housing and below the upper plenum, the compartment including a base, a back wall, a top wall and two side walls, the compartment sized to accommodate conventional microwave units; and
an intermediate conduit located at a rear end of the microwave compartment and is connected to the lower housing and the upper plenum so as to provide a channel through which air and fumes from the cooktop can flow to the blower unit, the conduit having a lower end connected to an opening in the lower housing adjacent to the filter, the conduit having an upper end connected to an opening in the upper plenum below the blower.

2. A ventilator hood assembly according to claim 1, wherein the lower housing includes lights mounted to a lower surface for illuminating a cooktop of the range.

3. A ventilator hood assembly according to claim 2, further comprising control knobs or switches mounted on the lower housing for controlling the blower and the lights.

4. A ventilator hood assembly according to claim 1, further comprising a temperature sensor mounted at or near the open bottom and connected to the controller, the temperature sensor adapted to sense the temperature of air at the open bottom; and wherein the controller is configured to control the motor based on the sensed temperature.

5. A ventilator hood assembly according to claim 1, wherein the compartment includes a vent that connects to an opening in the upper plenum or the conduit for channeling air from the compartment into the upper plenum.

6. A ventilator hood assembly according to claim 5, wherein the vent includes a flapper valve for controlling flow of air through the vent.

7. A ventilator hood assembly according to claim 1, further comprising a temperature sensor mounted within the compartment for sensing the temperature of the compartment, the sensor is connected to the controller, and wherein the controller is configured to control the motor based on the sensed temperature.

8. A ventilator hood assembly according to claim 1, wherein the conduit is configured to be located between the back wall of the compartment and a wall of a building upon which the hood assembly is mounted.

9. A ventilator hood assembly according to claim 1, wherein the conduit is configured to be mounted on the wall of the building, and wherein the upper end of the conduit includes a curved elbow portion that connects with or extends into an opening in a rear wall of the upper plenum, and a lower end of the conduit includes a curved elbow portion that connects with or extends into an opening in a rear wall of the lower housing.

10. A ventilator hood assembly according to claim 1, wherein there are two additional conduits, one extending along each side wall of the microwave compartment.

11. A ventilator hood assembly for mounting to a wall above a residential cooking range, the assembly comprising:
a lower housing including a removable baffle filter for capturing particulates entrapped in the air as it is drawn in from below the lower housing, and a light assembly configured to illuminate a surface below the lower housing;
an upper section including a blower unit powered by a motor, the blower unit, in operation, configured to draw air in from the open bottom through the filter and expel air through an outlet into an exhaust duct, and an upper plenum that channels the air into the blower unit;
a controller for controlling speed of the motor;
a microwave compartment located above the lower housing and below the upper plenum, the compartment including a base, a top wall and two side walls, the compartment sized to accommodate a conventional microwave unit;
an intermediate conduit located at a rear end of the microwave compartment and is connected to the lower housing and the upper plenum so as to provide a channel through which air and fumes from the cooktop can flow to the blower unit, the conduit having a lower end connected to an opening in the lower housing adjacent to the filter, the conduit having an upper end connected to an opening in the upper plenum below the blower, and the conduit configured to be mounted on the wall of the building, and
standoffs for mounting to the wall on either side of the conduit, the standoffs having a depth at least the same as the depth of the conduit, such that when the standoffs and the conduit are mounted to the wall, an outward facing surface of the standoffs provide a mounting surface for a microwave bracket.
